(19) United States
(12) Patent Application Publication
(10) Pub. No.: US 2007/0130069 A1
(43) Pub. Date: Jun. 7, 2007

(54) Encapsulating Address Components

(75) Inventors: Jeffrey B. Kay, Bellevue, WA (US); Eric D. Tribble, Bellevue, WA (US); Roy Williams, Woodinville, WA (US); Malcolm E. Pearson, Kirkland, WA (US); Trevor W. Freeman, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/276,535

(22) Filed: Mar. 3, 2006

Related U.S. Application Data
(60) Provisional application No. 60/742,617, filed on Dec. 6, 2005.

(51) Int. Cl. G06Q 99/00

(52) U.S. Cl. 705/50

(57) ABSTRACT

A transmitting node may utilize a shared secret to secure at least an encapsulated address component of an outbound message, and a receiving gateway may utilize the shared secret to authenticate and validate the secured addressed component of the received message.

### RELATED APPLICATIONS

This application claims priority benefit of U.S. Provisional Patent Application No. 60/742,617, filed on Dec. 6, 2005, by one or more of the present inventors and assigned to Microsoft Corporation, the assignee of the present application.

### BACKGROUND

The present description relates to the encryption of one or more encapsulated address components of a data package to thereby facilitate secure communications.

### SUMMARY

Described herein are systems and techniques by which a transmitting node may utilize a public key value related to an intended recipient to secure at least an encapsulated address component of an outbound communication and by which a receiving gateway may utilize a public key value related to a sender of the communication to authenticate and validate the secured addressed component of the received communication.

### DESCRIPTION OF THE DRAWINGS

The present description references the following figures.

FIG. 1 shows network communication nodes, with the nodes implementing example technologies relating to encapsulating address components.

FIG. 2 shows an example configuration of communications agents and corresponding communications gateways communicating over a network, implementing example technologies relating to encapsulating address components.

FIG. 3 shows an example configuration of a communications gateway, further to the example of FIG. 2.

FIG. 4 shows an example processing flow according to at least one implementation related to encapsulating address components.

### DETAILED DESCRIPTION

The present description relating to encapsulating address components may relate to systems, methodologies, techniques, processes, instructions, routines, and tools that may encapsulate one or more address components of a data package in order to facilitate secure communications between a sending node and a receiving node, typically in a network environment.

“Domain,” as referenced herein, may refer to, but not be limited to, one or more organizational logical collections of network end points that are capable of implementing network communication that may share a common naming suffix; such devices including, but not limited to, servers, client devices, or other device or various combinations thereof.

“Gateway,” as referenced herein, may refer to, but is not limited to, one or more devices that facilitate interaction between two or more domains, networks, or sub-networks. Thus, a gateway may function as either an entry point or an exit point for a respective domain or network. Transport protocol conversion may not be required, but some form of processing is typically performed.

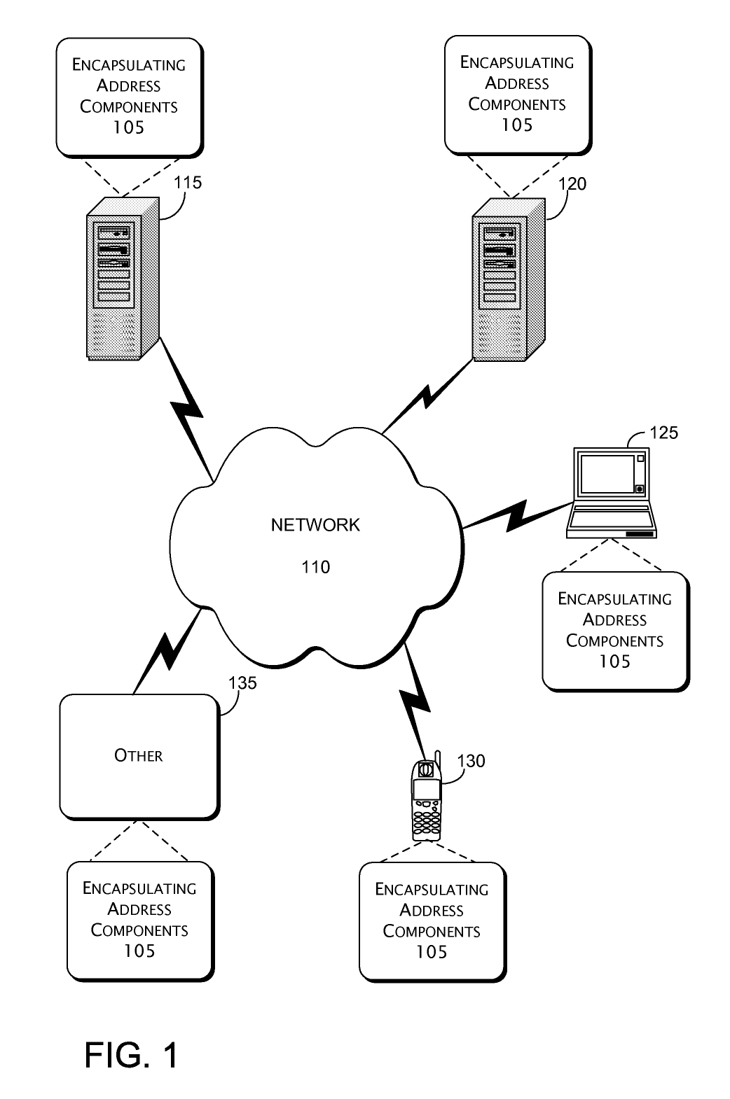

FIG. 1 shows example network environment 100 in which example technologies related to encapsulating address components 105 may be implemented over network 110. In FIG. 1, server devices 115 and 120, client device 125, handheld client device 130, and “other” device 135 may be communicatively coupled to one another via network 110; and, further, at least one of server devices 115 and 120, client device 125, handheld client device 130, and “other” device 135 may be capable of implementing the aforementioned technologies.

Server devices 115 and 120 may represent devices, such as domain-related receivers or gateways, which are capable of transmitting and receiving electronic packages (e.g., e-mail or audio/video packets) or any other of a variety of data and/or functionality in relation to other devices in network environment 100. Implementations related to encapsulating address components 105 may be applicable to an exchange of electronic packages between server devices 115 and 120 in the clear (i.e., without any security measures implemented thereon); although alternative implementations may be applicable even if data to be exchanged is restricted to certain users or only if an appropriate subscription or licensing fee is paid. Server devices 115 and 120 may be at least one of a data package receiver, gateway, mail transport agent (MTA), domain server, network server, application server, blade server, or any combination thereof. Typically, server devices 115 and 120 may represent devices that may be a content source, and client devices 125 and 130 may represent any device that may receive such content either via network 110 or in an off-line manner. However, according to the example implementations described herein, server devices 115 and 120 and client devices 125 and 130 may interchangeably be sending nodes or receiving nodes in network environment 100. More particularly, relative to each other, server devices 115 and 120 may interchangeably be a sending node and a receiving node. “Other” device 135 may also be embodied by any of the above examples of server devices 115 and 120.

Client device 125 may represent at least one of a variety of known computing devices, including a laptop computer, desktop personal computer (PC), workstation, mainframe computer, Internet appliance, media center, or set-top box that may be associated with network 110 by either a wired or wireless link, and is able to implement example technologies related to encapsulating address components 105. Further, client device 125 may represent the client devices described above in various quantities and/or combinations thereof. “Other” device 135 may also be embodied by any of the above examples of client device 125.

Handheld client device 130 may represent at least one device that is capable of being associated with network 110 by a wireless link, including a mobile (i.e., cellular) telephone, personal digital assistant (PDA), etc., and is able to implement example technologies related to encapsulating address components 105. Further, handheld device 130 may represent the handheld devices described above in various quantities and/or combinations thereof. “Other” device 135 may also be embodied by any of the above examples of handheld client device 130.

“Other” device 135 may represent any further device that is capable of implementing technologies related to encapsulating address components 105 according to one or more of the examples described herein. That is, “other” device 135 may represent any computing or processing device that is capable of at least storing and sharing security information for any other of the devices associated with network 110, and sending or receiving electronic packages (e.g., e-mail or audio/video packets) in relation to any other devices associated with network 110. Thus, “other” device 135 may be a computing or processing device having at least one of an operating system, an interpreter, converter, compiler, or runtime execution environment implemented thereon. These examples are not intended to be limiting in any way, and therefore should not be construed in that manner.

Network 110 may represent any of a variety of conventional network topologies and types, which may include wired and/or wireless networks. Network 110 may further utilize any of a variety of conventional network protocols, including public and/or proprietary protocols. Network 110 may include, for example, the Internet as well at least portions of one or more local area networks (also referred to, individually, as a “LAN”), such as an 802.11 system or, on a larger scale, a wide area network (i.e., WAN”); or a personal area network (i.e., PAN), such as Bluetooth.

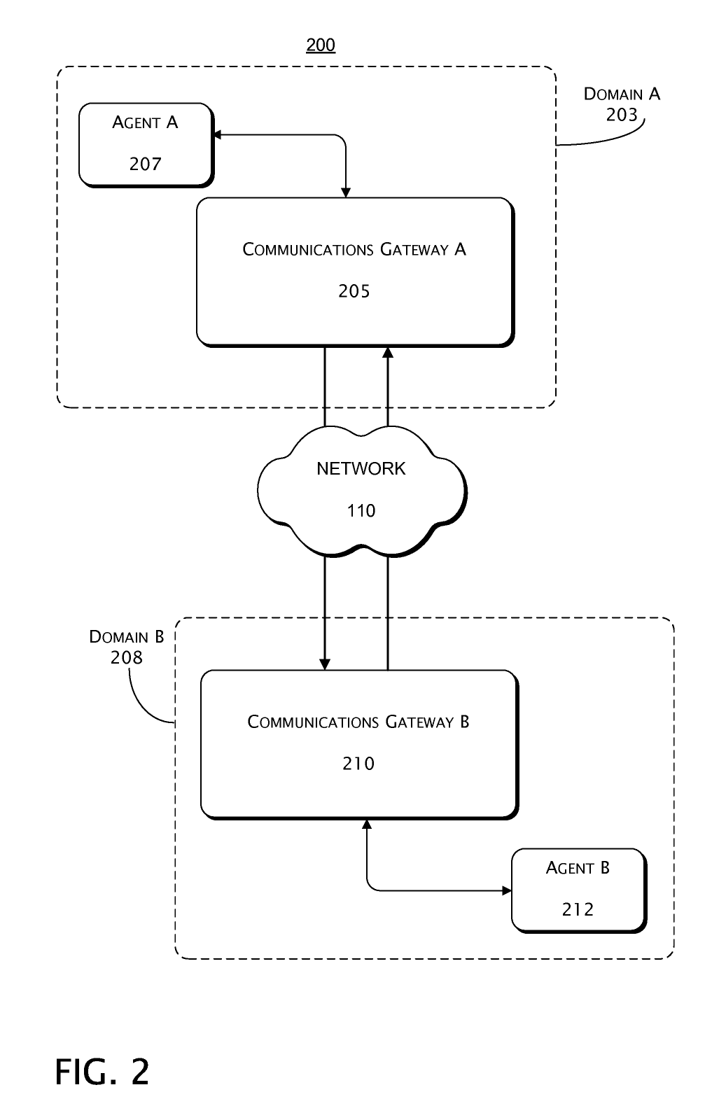

FIG. 2 shows example network environment 200 in which communication agents and corresponding communications gateways communicate over network 110, implementing example technologies pertaining to encapsulating address components 105 (see FIG. 1).

Communications gateway A 205 may represent a gateway device, MTA (e.g., SMTP server), receiver, or a combination thereof on domain A 203. Communications gateway A 205 may further be associated with a domain name server having a distributed database as part of the domain naming system (DNS). Communications gateway A 205 may be capable of transmitting and receiving electronic packages (e.g., e-mail or audio/video packets) to other devices, on behalf of agent A 207, over network 110. Such transmitting and receiving of messages may be implemented by, e.g., simple mail transfer protocol (SMTP). Further, as part of DNS, communications gateway A 205 may convert requests from programs into IP addresses on domain A 203, and accept requests from other name servers to convert domain names into IP addresses.

Agent A 207 may represent at least one of a variety of known computing devices on domain A 203 capable of transmitting an electronic package (i.e., e-mail or audio/video packets) to one or more nodes on network 110. Such devices may include, but are not limited to, a client device or handheld device. More particularly, agent A 207 may be a source of an electronic package that is intended for a counterpart agent associated with network 110. The electronic packages referenced herein may include e-mail that may or may not have one or more files attached thereto. Such an attached file may include, as non-limiting examples, a text file, an audio file, a video file, a uniform resource locator (URL), etc. Alternative implementations related to encapsulating address components 105 may further contemplate scenarios in which the electronic package to be transmitted is an instant message, a stream of audio packets such as those utilized by voice over IP (VoIP) protocols, or a direct download of electronic packets (i.e., text, audio, video, etc.) from an agent in one domain to an agent in another domain or, even further, from one gateway to another as directed by an agent.

Network 110, as described above, may represent any of a variety of conventional network topologies and types, which may include wired and/or wireless networks. Network 110 may include, for example, the Internet as well at least portions of one or more LANs, a WAN, or a PAN.

Communications gateway B 210 may be a gateway device, MTA, receiver, or combination thereof on domain B 208. That is, communications gateway B 210 may be an intended receiving gateway and DNS database counterpart to transmitting communications gateway A 205.

Agent B 212, accordingly, may be an intended receiving counterpart to sending agent A 207 from which an electronic package (i.e., e-mail or audio/video packets) may originate.

Encapsulating address components 105, according to at least one example in network environment 200, may incorporate distributed symmetric keys associated with, e.g., communication that is managed at a high level between domain A 205 and domain B 208 or an alternative communication that is managed more particularly between communications gateway A 205 and communications gateway B 210. Regardless of the example communication scenario, implementations related to encapsulating address components 105 may include each node generating symmetric keys (i.e., a private and a public key value), receiving a public key value from a counterpart node of the respective example pairing either over network 110 or via an out-of-band mechanism, and generating a secret value as a function of the locally generated private key value and the public key value received from the counterpart node.

For example, implementations related to encapsulating address components 105 may include securing an electronic package sent from agent A 207 via communications gateway A 205 using a public key value associated with domain B, in which an intended recipient (i.e., agent B 212) of the electronic package is disposed. The public key value associated with domain B 208 may be more particularly associated communications gateway B 210, agent B 212, or even a user of agent B 212. However, the present description, unless otherwise noted, relates to implementations of encapsulating address components 105 using a public key value associated with domain B 208. The symmetric keys associated with domain B 208 are described herein as being generated and stored at communications gateway B 210. However, by one or more alternative implementations, such private/public key pair may be generated and stored at agent B 212 or, even further, at a storage device or database that is associated with domain B 208 yet disposed separately on network 110. This description regarding the symmetric keys associated with domain B 208 is applicable, of course, to domain A 203. Further alternative implementations should be obvious in view of the present description, and therefore the examples described herein should not be construed as limiting in any manner.

Thus, according to at least one example implementation related to encapsulating address components 105, symmetric keys are established for both domain A 203 and domain B 208. The public key values corresponding to domain A 203 and domain B 208, respectively, may be stored at communications gateway A 205 and communications gateway B 210. Alternatively, however, such public keys may be stored at a storage device or database that is associated with the respective domains yet disposed separately on network 110. Even further, the public keys may be made available via an out-of-band mechanism.

Additionally, though the implementations related to encapsulating address components 105 are not beholden to a particular transmitting protocol, and therefore no such limitations should be inferred, the present description may contemplate electronic packages being transmitted between domain A 203 and domain B 208 using SMTP (simple mail transfer protocol).

Agent A 207 may be a client device from which an outbound electronic package (i.e., e-mail or audio/video packets) intended for agent B 212 originates. The outbound electronic package may be received at communications gateway A 205, which, similar to agent A 207, may be associated with domain A 203.

Communications gateway A 205 may retrieve a public key value for domain B 208 from communications gateway B 208 or from a storage device associated with domain B 208. Alternative implementations may further contemplate communications gateway A 205 retrieving the public key value for domain B 208 from a local storage device associated with domain A 203. The public key value for domain B 208 may alternatively be retrieved from a DNS database that may or may not be associated with domain B 208 or via an out-of-band mechanism. Further, agent B 212 may not necessarily be the only intended recipient of the outbound electronic package, and therefore communications gateway A 205 may further retrieve a public key value for other domains that are respectively associated with other intended recipients of the outbound electronic package. However, unless otherwise noted, the present description refers to agent B 212 as the sole intended recipient of the electronic package from agent A 207.

Having retrieved the public key value for domain B 208, communications gateway A 205 may utilize the retrieved public key value to encrypt and thereby secure at least one or more encapsulated address components of the outbound electronic package. According to at least one implementation related to encapsulating address components 105, communications gateway A 205 may secure at least the one or more encapsulated address components of the outbound electronic package by using a shared secret generated as a function of a combination of the retrieved public key value and the private component of the locally generated key pair. In light of the keys used to generate the shared secret, shared secrets may alternatively be referred to as a “compiled key” in the present description.

The example implementations related to encapsulating address components 105 described herein contemplate the usage of Diffie-Hellman (alternatively referred to herein as “DH”) private/public key pairs. Alternative implementations, therefore, may incorporate such private/public key pairs for elliptical curve Diffie-Hellman (ECDH). Regardless, a DH shared secret (alternatively referred to herein as “DHSS”) for domain A 203 may be generated as a function of the private key value for domain A 203 and the retrieved public key value for domain B 208. Further, a DHSS for domain B 208 may be generated as a function of the private key value for domain B 208 and a retrieved public key value for domain A 203. By such examples, the aforementioned DHSS for domain A 203 is the same as the DHSS for domain B 208. That is, by exchanging public keys, the DHSS generated on domain A 203 and domain B 208 are the same even though neither domain is required to export either a private key value or a shared secret value over network 110. Rather, only a public key value is shared from one domain to another, requiring a low level of trust.

However, at least one alternative implementation related to encapsulating address components 105 may utilize a secret value shared among domain A 203 and domain B 208 using the Rivest-Shamir-Adleman (hereafter “RSA”) cryptographic protocol. According to at least one such example, a secret value may be generated in association with either domain A 203 or domain B 208 and, if shared, protected by the public key value corresponding to the destination domain. More particularly, to implement the RSA protocol, a public key value may be generated in association with both domain A 203 and domain B 208, though a private key value need be generated in association with only the domain on which the shared secret is to be generated. Thus, for example, a public key value may be generated in association with domain A 203 and for domain B 208; a private key value may be generated in association with domain A 203; a shared secret may be generated in association with domain A 203 as a function of the private key value associated with domain A and the public key value associated with domain B 208; and the shared secret may be protected by the public key value associated with domain B 208 and, further, be retrieved for utilization on domain B 208.

Regardless, after receiving the outbound electronic package, communications gateway A 205 may secure at least one or more encapsulated address components of the outbound electronic package using the shared secret, and transmit, via network 110, the secured outbound electronic package to communications gateway 210 corresponding to intended recipient agent B 212. According to at least one example implementation, a public key value associated with domain A 203 may be attached, or otherwise incorporated in, to the outbound electronic package. For example, a DH public key value associated with domain A 203 may be embedded in an encrypted encapsulated address component (e.g., MAIL FROM).

Communications gateway B 210, upon receiving the secured electronic package, via network 110, may determine domain A 203 to be the source of the electronic package. Thus, communications gateway B 210 may extract a public key value for domain A from the secured electronic package. Alternatively, if the public key value for the domain from which the electronic package is not attached thereto, such public key value may be retrieved from communications gateway A 205 or from storage associated with domain A 203 or a DNS database.

Communications gateway B 210 may utilize the public key value for domain A 203 to re-construct the shared secret (e.g., DHSS), which may be generated as a function of the private key value for domain B 208 and the public key value for domain B 203. That is, the shared secret generated at domain B 208 is the same as the shared secret generated at domain A 203.

Communications gateway B 210 may utilize the shared secret to decrypt the one or more encapsulated address components of the received electronic package. The encrypted encapsulated address components may pertain to the sender of the electronic package or a receiver of the electronic package.

According to at least one implementation related to encapsulating address components 105, the encapsulated address components may include, but not necessarily be limited to, the “MAIL FROM” portion of a transmitting party's address information and the “RCPT TO” portion of a receiving party's address information. More particularly, an encrypted MAIL FROM may obscure an identity associated with a user or device from which the electronic package originates, but may leave in the clear an identity associated with the domain from which the electronic package originates. Further, an encrypted RCPT TO may obscure an identity associated with a user or device to which an electronic package is intended, but may leave in the clear an identity associated with the domain to which the electronic package may be intended. Thus, in the context of the electronic package being an e-mail message from an originating node associated with sample domain “XX.com” to a receiving node associated with sample domain “YY.com”, the MAIL FROM may be identified from the sending address of “MAIL FROM obscured_sender@ XX.com” and the RCPT TO may be identified from a receiving address of “RCPT TO obscured_receiver@ YY.com”. In such example, “obscured_sender” and “obscured_receiver” are, respectively, encrypted versions of the real sender username and real receiver username. The implementations related to encapsulating address components 105 is not limited to domains as they pertain to e-mail or packet delivery, of course, and therefore the sample domains described above should not be inferred as limiting. The domains associated with an obscured identity corresponding to a sending or receiving node may further pertain to internet-based telephony and other forms of data exchange.

In the event that the MAIL FROM associated with the electronic package is encrypted, communications gateway B 210 may utilize the shared secret to decrypt the encapsulated address component of the received electronic package, and implement predetermined techniques to authenticate the sender at domain B 208. Further, the shared secret may be used to decrypt the substance of the electronic package in the event that the shared secret was used to encrypt the same at domain A 203.

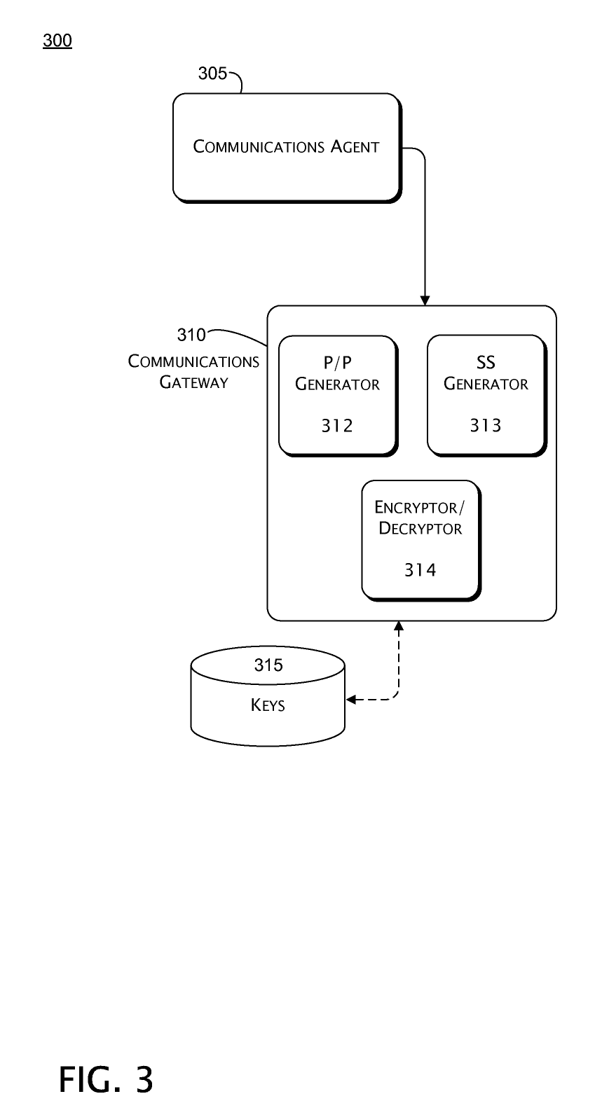

FIG. 3 shows example configuration 300 of a communications gateway, further to the example of FIG. 2.

In the following description, various operations may be described as being performed by, or otherwise in association with, features described above with reference to FIGS. 1 and 2. Physical and operational features described with respect to configuration 300 may be implemented as hardware, firmware, or software, either singularly or in various combinations together.

Agent 305 may be representative of either agent A 207 or agent B 212 described above with reference to FIG. 2. More particularly, agent 305 may represent a client device capable of originating an electronic package to be transmitted to one or more nodes on network 110 and capable of receiving such an electronic package via a corresponding communications gateway.

Communications gateway 310 may be representative of either transmitting communications gateway A 205 or receiving communications gateway B 210 described above with reference to FIG. 2, and therefore this description of FIG. 3 may refer to communications gateway 310 as transmitting communications gateway 310 or receiving communications gateway 310, depending upon the role thereof. Further, communications agent 310 may represent a gateway device, MTA, or receiver that may or may not be further implemented as a distributed storage system as part of the domain naming system (DNS).

Communications gateway 310 may be capable of transmitting and receiving electronic packages in relation to other devices, particularly other gateways, over network 110. Such transmitting and receiving of messages may be implemented by, e.g., SMTP.

Further still, a transmitting communications gateway 310 may be capable of accessing a receiving communications gateway 310 or, alternatively, a DNS database to retrieve a corresponding public key value associated with an intended recipient of an electronic package. The retrieved public key value may be associated with a domain corresponding to an intended recipient, a communications gateway corresponding to an intended recipient, a device corresponding to an intended recipient, or even a user who is an intended recipient. However, the present description, unless otherwise noted, relates to transmitting communications gateway 310 accessing and retrieving a public key value associated with a domain corresponding to an intended recipient of an electronic package.

In addition, a transmitting communications gateway 310 may be capable of generating random encryption keys according to various implementations of encapsulating address components 105. More particularly, communications gateway 310, according to at least one example implementation related to encapsulating address components 105 may include one or more of symmetric key (i.e., private/public or “P/P”) generator 312, shared secret (SS) generator 313, and encryptor/decryptor (E/D) 314.

P/P generator 312 may generate a local P/P key pair for the domain with which communications gateway 310 is associated. Alternatively, the generated P/P key pair may be associated with communications gateway 310, communications agent 305, or even a user of communications agent 305.

S/S generator 313 may generate a shared secret by utilizing the retrieved public key value the local private key value. More particularly, S/S generator 313 may generate a DHSS as a function of the private key value produced by P/P generator 312 and the public key value imported from an intended recipient of the electronic package.

E/D 314 may encrypt and decrypt, at least, encapsulated address components associated with an electronic package using a shared secret generated by S/S generator 313. E/D 314 may further encrypt portions of an outbound electronic package, including encapsulated address components, by utilizing a symmetric algorithm, in combination with the shared secret.

Storage device 315 may be associated with communications gateway 310 either logically or physically. That is, storage device 315 may be associated with a domain to which communications gateway 310 corresponds without being physically disposed within such domain. More particularly, storage device 315 may be a component of the distributed DNS database corresponding to the domain of communications gateway 310.

Storage device 315 may store, in various combinations thereof, one or more public and private encryption key pairs that are generated by P/P generator 312 or are acquired from another source. For example, when associated with receiving communications gateway 310, storage device 315 may store one or more retrieved public key values for a domain corresponding to an intended recipient of an electronic package. Such retrieved public key values may be used to secure encapsulated address components of an electronic package intended for the domain corresponding to the intended recipient thereof. Alternatively, when associated with transmitting communications gateway 310, storage device 315 may store one or more public key values for the domain corresponding to the source of an electronic package. Such retrieved public encryption keys may be used to authorize, validate, and decrypt encapsulated address components of an electronic package.

Regardless of whether communications gateway 310 is a transmitting communications gateway or a receiving communications gateway, storage device 315 may also store therein private key values corresponding to the domain to which communications gateway 310 is associated. That is, in association with domain A 203, storage device 315 may store private key values corresponding to domain A 203, an agent or device associate with domain A 203, or a user associated with domain A 203; and, conversely, in association with domain B 208, storage device 315 may store private key values corresponding to domain B 208, an agent or device associate with domain B 208, or a user associated with domain B 208.

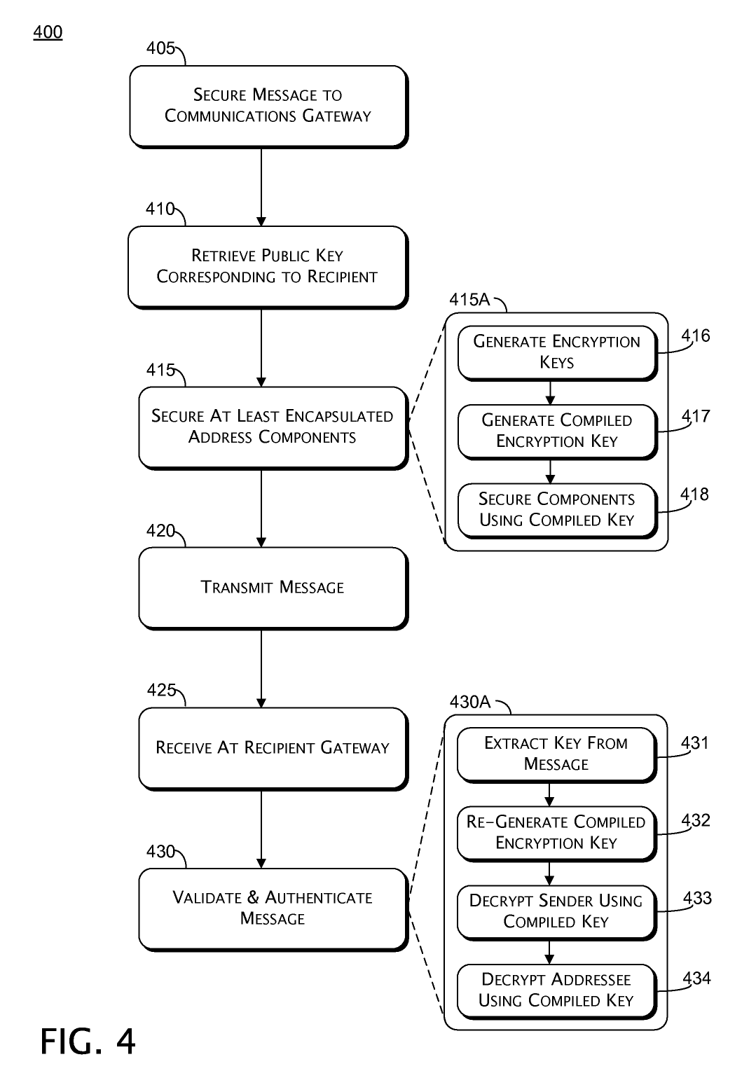

FIG. 4 shows example processing flow 400 according to at least one implementation related to encapsulating address components 105 (see FIG. 1). Various operations described as part of processing flow 400 may be attributed as being performed by, or otherwise in association with, features described above with reference to FIGS. 1-3. Such attributions, as well as the operations, are described as examples only, and the operations may be implemented as hardware, firmware, or software, either singularly or in various combinations together.

Processing flow 400 is described below with reference to example implementations A and B. Such implementations are not described in any order of preference, nor are the implementations to be construed as limiting in scope. Rather, the example implementations are provided to illustrate the flexibility and variance enabled by encapsulating address components 105.

### EXAMPLE IMPLEMENTATION A

Block 405 may refer to communications gateway A 205 receiving an electronic package (i.e., e-mail or audio/video packets) from agent A 207 (i.e., client device) for transmittal beyond domain A 203. According to at least one alternative implementation, block 405 may refer to communications gateway A 205 as a content source independent of agent A 207. Regardless, block 405 may refer to at least one intended recipient of the electronic package received at communications gateway A 205 being associated with domain B 208.

Block 410 may refer to communications gateway A 205 retrieving a public key value that is associated with domain B 208. Thus, communications gateway A 205 may access communications gateway B 210, storage device 315, or a DNS server that may or may not be associated with communications gateway B 210, to retrieve a public key value for domain B 208.

Block 415 may refer to communications gateway A 205 encrypting one or more encapsulated address components associated with an outbound electronic package using at least the public key value for domain B 208 as well as a private signing key for domain A 203, which may be stored locally at, or otherwise associated with, domain A 203.

More particularly, block 415 may refer to communications gateway A 205 encrypting at least the MAIL FROM and likely the RCPT TO corresponding to an outbound electronic package using a DHSS generated at, or in association with, communications gateway A 205.

Block 420 may refer to the electronic package having encrypted encapsulated address components being transmitted from communications gateway A 205 to communications gateway B 210 over network 110. Further the electronic package may have the public key value associated with domain A 203 attached thereto or, alternatively, such public key value may be transmitted to an intended recipient of the electronic value via an out-of-band mechanism. Typically, block 420 may refer to the electronic package being transported in accordance with SMTP. Encapsulating address components 105, however, is not beholden to SMTP.

Block 425 may refer to the electronic package being received at communications gateway B 210.

Block 430 may refer to communications gateway B 210 validating and authenticating the encapsulated address components associated with the received electronic package. By this first example, communications gateway B 210 may detect that the received electronic package originated from domain A 203. Communications gateway B 210 may then extract the public key value associated with domain A 203 from the electronic package or, alternatively, from an out-of-band mechanism by which such public key value may have been transmitted to communications gateway B 210.

Regardless, the public key value associated with domain A 203 and the private key value associated with domain B 208 may be used to re-generate the shared secret at communications gateway B 210. The shared secret, which is equal to the shared secret used at communications gateway A 205, may be utilized to decrypt and therefore authenticate, the encrypted address component corresponding to the sender (e.g., MAIL FROM) of the electronic package.

Block 430 may further refer to communications gateway B 210 using the shared secret to decrypt the encrypted address component corresponding to an intended recipient (e.g., RCPT TO) of the electronic package associated with domain B 208.

Further still, any further portion of the electronic package that may have been encrypted using the shared secret at communications gateway A 205 may be decrypted using the shared secret at communications gateway B 210.

Having authenticated and decrypted encapsulated address components associated with the electronic package at block 430, communications gateway B 210 may then transmit the electronic package to the intended recipient agent B 212.

### EXAMPLE IMPLEMENTATION B

Block 405 may refer to communications gateway A 205 receiving an electronic package from agent A 207 for transmittal beyond domain A 203. Block 405 may refer to communications gateway A 205 as a content source independent of agent A 207 and one or more intended recipients of the electronic package being associated with domain B 208 (e.g., agent B 212).

Block 410 may refer to communications gateway A 205 retrieving a public key value that is associated with domain B 208. Thus, communications gateway A 205 may access communications gateway B 210, storage device 315, or a DNS server that may or may not be associated with communications gateway B 210, to retrieve a public key value for domain B 208.

As set forth above, agent B 212 may not be the only intended recipient of the electronic package, and therefore block 410 may further refer to communications gateway A 205 retrieving a public key value for other domains that are respectively associated with other intended recipients of the outbound electronic package.

Block 415A may refer to communications gateway A 205 securing the outbound message in accordance with the processing described for, at least, blocks 416-418.

Block 416 may refer to communications gateway A 205, or an entity associated therewith, generating a random private/public key pair (i.e., DH key pair).

Block 417 may refer to communications gateway A 205, or an entity associated therewith, generating a DHSS as a function of the retrieved public key value that is associated with domain B 208 and a private key value associated with domain A 203.

In the event that agent B 212 is not the only intended recipient of the electronic package associated with domain B 208, block 417 may further refer to communications gateway A 205 generating a DHSS for each of the intended recipients based on a public key value associated with each of the intended recipients associated with domain B 208.

Block 418 may refer to communications gateway A 205 using at least the DHSS to encrypt the MAIL FROM and RCPT TO with a symmetric algorithm, such as AES (advanced encryption algorithm), that use the DHSS as the encryption key. Such symmetric algorithm is referred to only as an example, and no reasonable inference may be made that implementations related to encapsulating address components 105 are so limited.

Block 418 may also refer to communications gateway A 205 using the DHSS to further obscure the encrypted MAIL FROM address component associated with the electronic package by attaching thereto, or otherwise associating therewith, the public key value associated with domain A 203, and a string of flags that include, at least, an indication of the symmetric algorithm used to encrypt the encapsulated address components and an initialization vector.

In the event that agent B 212 is not even the only intended recipient of the electronic package associated with domain B 208, block 418 may further refer to communications gateway A 205 further securing the electronic package with a locally generated encryption key using the DHSS for each of the intended recipients. The randomly generated encryption key may then be hashed with a public key value for each of the intended recipients. Thus, a single encrypted electronic package may be encrypted for multiple recipients associated with domain B 208.

Block 420 may refer to the electronic package having encrypted encapsulated address components being transmitted from communications gateway A 205 to communications gateway B 210 over network 110. Typically, block 420 may refer to the electronic package being transported in accordance with SMTP, although implementations related to encapsulating address components 105, as stated above, are not beholden to SMTP.

Block 425 may refer to the electronic package being received at communications gateway B 210.

Block 430A may refer to communications gateway B 210 validating and authenticating the address components of the electronic package in accordance with the processing described for, at least, blocks 431-434.

Block 431 may refer to communications gateway B 210 extracting the public key value associated with domain A 203 and the string of flags that are attached to, or otherwise incorporated within, the electronic package.

Block 432 may refer to communications gateway B 210 re-generating the DHSS as a function of the public key value associated with domain A 203, extracted from the electronic package, and the private key value associated with domain B 208.

Block 433 may refer to communications gateway B 210 using the DHSS, which is equal to the shared secret used at communications gateway A 205, and the encryption algorithm that was attached to or associated with the electronic package, to decrypt the encrypted address component corresponding to the sender (e.g., MAIL FROM) of the electronic package.

Block 434 may refer to communications gateway B 210 using the DHSS to decrypt the encrypted address component corresponding to an intended recipient (e.g., RCPT TO) of the electronic package associated with domain B 208.

Further still, any further portion of the electronic package that may have been encrypted using the DHSS at communications gateway A 205 may be decrypted using the shared secret at communications gateway B 210.

In the event that agent B 212 is not the only intended recipient of the electronic package associated with domain B 208, block 434 may further refer to communications gateway B 210 further decrypting the encryption key randomly generated at communications gateway A 205, which was used to encrypt the electronic package using the DHSS for each of the intended recipients.

Having authenticated and decrypted encapsulated address components associated with the electronic package at block 430, communications gateway B 210 may then transmit the electronic package to the intended recipient agent B 212.

By the description above, pertaining to FIGS. 1-4, encapsulated address components may be encrypted for securing, authenticating, and validating electronic packages (e.g., e-mail or audio/video packets) sent over a network from one domain to another. However, the example implementations described herein are not limited to just the network environments of FIGS. 1 and 2, the components of FIG. 3, or the processing flow of FIG. 4. Technologies (e.g., tools, methodologies, and systems) associated with encapsulated address components 105 (see FIG. 1) may be implemented by various combinations of the components described with reference to FIG. 3, as well as in various orders of the blocks described with reference to FIG. 4.

Further, the computer environment for any of the examples and implementations described above may include a computing device having, for example, one or more processors or processing units, a system memory, and a system bus to couple various system components.

The computing device may include a variety of computer readable media, including both volatile and non-volatile media, removable and non-removable media. The system memory may include computer readable media in the form of volatile memory, such as random access memory (RAM); and/or non-volatile memory, such as read only memory (ROM) or flash RAM. It is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electric erasable programmable read-only memory (EEPROM), and the like, can also be utilized to implement the example computing system and environment.

Reference has been made throughout this specification to “an example,” “alternative examples,” “at least one example,” “an implementation,” or “an example implementation” meaning that a particular described feature, structure, or characteristic is included in at least one implementation of the present invention. Thus, usage of such phrases may refer to more than just one implementation. Furthermore, the described features, structures, or characteristics may be combined in any suitable manner in one or more implementations.

One skilled in the relevant art may recognize, however, that code module initialization may be implemented without one or more of the specific details, or with other methods, resources, materials, etc. In other instances, well known structures, resources, or operations have not been shown or described in detail merely to avoid obscuring aspects of the invention.

While example implementations and applications of the code module initialization have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the invention, as both described above and claimed below.

We claim:

1. At least one computer-readable medium having one or more executable instructions that, when read, cause one or more processors to:
retrieve a public key value,
encrypt address information associated with an outbound data package using at least the public key value;
construct origin information associated with the outbound data package using at least the public key value; and
transmit the outbound message.

2. At least one computer-readable medium according to claim 1, wherein the retrieved public key value is a public Diffie-Hellman key.

3. A least one computer-readable medium according to claim 1, wherein the retrieved public key value is retrieved from a DNS server associated with an intended recipient of the outbound message.

4. At least one computer-readable medium according to claim 1, wherein the one or more instructions to encrypt the address information, when read, cause the one or more processors to:
generate a local encryption key pair;
generate a compiled encryption key using the retrieved public key value and a component of the local encryption key pair; and
encrypt, using the compiled encryption key, address information pertaining to at least one of an origin and a destination of the outbound data package.

5. At least one computer-readable medium according to claim 1, wherein the one or more instructions to encrypt the address information, when read, cause the one or more processors to:
generate a local Diffie-Hellman key pair;
generate a Diffie-Hellman shared secret using the retrieved public key value and a private component of the local Diffie-Hellman key pair; and
encrypt a MAIL FROM and RCPT TO of the outbound data package with an encryption algorithm that uses the Diffie-Hellman shared secret.

6. At least one computer-readable medium according to claim 1, wherein the one or more instructions to construct the origin information associated with the outbound data package, when read, cause the one or more processors to:
attach a portion of the encrypted address information to an indication of an encryption algorithm used to encrypt the address information.

7. At least one computer-readable medium according to claim 1, wherein the one or more instructions to construct the destination associated with the outbound data package, when read, cause the one or more processors to:
attach an encrypted address MAIL FROM parsed from the encrypted address information to a string of flags indicative of an encryption algorithm used to encrypt the address information and an initialization vector.

8. At least one computer-readable medium having one or more executable instructions that, when read, cause one or more processors to:
detect encrypted origin information associated with a received data package;
extract components of an encryption algorithm from the received data package;
decrypt the encrypted origin information associated with the received data package using at least a portion of the extracted components of the encryption algorithm.

9. At least one computer-readable medium according to claim 8, wherein the encrypted origin information includes a MAIL FROM associated with the received data package.

10. At least one computer-readable medium according to claim 8, wherein the one or more instructions to extract, when read, cause the one or more processors to extract a public key value associated with a sender of the received data package.

11. At least one computer-readable medium according to claim 8, wherein the one or more instructions to extract, when read, cause the one or more processors to extract a public key value associated with a sender of the received data package, a flag indicative of an encryption algorithm used to encrypt the origin information associated with the received data package, and a flag indicative of an initialization vector.

12. At least one computer-readable medium according to claim 8, wherein the one or more instructions to extract, when read, cause the one or more processors to extract a public Diffie-Hellman key value associated with a sender of the received data package.

13. At least one computer-readable medium according to claim 8, wherein the one or more instructions to decrypt, when read, cause the one or more processors to:
re-generate, using a local private encryption key, a compiled encryption key used to encrypt the encrypted origin information associated with the received data package.

14. At least one computer-readable medium according to claim 8, wherein the one or more instructions to decrypt, when read, cause the one or more processors to:
compute a Diffie-Hellman shared secret using a local private Diffie-Hellman key and a public Diffie-Hellman key associated with a sender of the received package; and
decrypt an encrypted MAIL FROM associated with the received data package using the Diffie-Hellman shared secret.

15. At least one computer-readable medium according to claim 8, wherein the one or more instructions to decrypt, when read, cause the one or more processors to:
decrypt an encrypted MAIL FROM associated with the received data package using a locally generated Diffie-Hellman shared secret; and
decrypt an encrypted RCPT TO using the locally generated Diffie-Hellman shared secret.

16. At least one computer-readable medium according to claim 8, wherein the one or more instructions to decrypt, when read, cause the one or more processors to an encrypted RCPT TO corresponding to a recipient of the data package using a locally generated Diffie-Hellman shared secret.

17. A system, comprising:
means for generating a Diffie-Hellman shared secret;
means for encrypting a portion of address information associated with a data package using the Diffie-Hellman shared secret; and
means for attaching a public Diffie-Hellman key value to the data package.

18. A system according to claim 17, further comprising means for encrypting a portion of the contents of the data package using the Diffie-Hellman shared secret.

19. A system according to claim 17, wherein the means for encrypting is to encrypt a MAIL FROM associated with the data package using the Diffie-Hellman shared secret.

20. A system according to claim 17, wherein the means for encrypting is to encrypt a RCPT TO associated with only the second node using the Diffie-Hellman shared secret.
